(19) United States
(12) Patent Application Publication
(10) Pub. No.: US 2007/0204691 A1
(43) Pub. Date: Sep. 6, 2007

(54) SYSTEM AND METHOD FOR MONITORING CONDITIONS AND EVENTS

(76) Inventors: James T. Bogner, Carmel, IN (US); Robert Brill, Elmira, NY (US); William G. Hopkins, Laguna Hills, CA (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/685,492

(22) Filed: Mar. 13, 2007

Related U.S. Application Data
(63) Continuation-in-part of application No. 10/912,322, filed on Aug. 5, 2004.
(60) Provisional application No. 60/492,547, filed on Aug. 5, 2003.

(51) Int. Cl. G01D 21/00

(52) U.S. Cl. 73/432.1

(57) ABSTRACT

A condition management system monitors a variety of biological and environmental conditions for individuals, locations, and objects. Information collected with respect to the various conditions monitored is processed to create an information hierarchy that controls the operation of various alert devices. The alert devices may operate via wired or wireless technology. Quantitative measurements can be made with respect to the monitored conditions in order to create the information hierarchy. Important or critical conditions can take precedent over less critical conditions both in terms of the nature of the alert and the processing order.

### CROSS-REFERENCE TO RELATED APPLICATIONS

The present application is a continuation-in-part of U.S. patent application Ser. No. 10/912,322, filed on Aug. 5, 2004, which claims the benefit of U.S. Provisional Application Ser. No. 60/492,547 filed on Aug. 5, 2003, which are hereby incorporated by reference in their entirety.

### FIELD

The disclosure relates generally to methods and apparatus for monitoring and detecting events and the status of conditions, and more particularly, to using the information obtained from such condition monitoring and detecting in order to determine appropriate responses to such events and status conditions.

### BACKGROUND

It is becoming increasingly important to be able to accurately monitor the status of a variety of conditions or events related to both people and objects, as well as being able to access and use the information collected in a variety of ways, both locally as well as distant from the source of the monitored condition. As one example, it is estimated that one-third to one-half of all nursing home residents are incontinent. Incontinence problems are often neglected, unchecked or otherwise mismanaged by healthcare personnel, thereby causing discomfort and unpleasantness for the patients, and often creating further health complications. As an example, many residents suffer from pressure sores (decubitus ulcers) that occur as a result of unrelieved pressure on the skin due to lack of movement. These decubitus ulcers are exacerbated by poorly managed incontinence problems, i.e., failure to change a patient's diaper or bedding when wet.

The problems in nursing homes and other managed care facilities are not limited to incontinence management. A state of crisis has been recognized in the U.S. among nursing homes, largely attributed to shortages in qualified caregivers. Common problems in care received by patients include, in addition to incontinence, malnutrition, dehydration, irregular and incorrect administration of medication, patients wandering outside of their rooms, and abuse of patients by healthcare workers. The poor care received in these institutions is often most frustrating for the patients' family and loved ones, who often cannot regularly monitor the level of care their friend or family member is receiving.

Furthermore, the problems associated with monitoring individuals are not limited to nursing homes or health care facilities. They also extend to daycare facilities, nurseries, schools, and even individual homes. When the care of infants or children is involved, problems may arise ranging from a child who wanders unnoticed from their room to an infant who stops breathing while they are believed to be asleep.

Additionally, there is a growing need to monitor the status of objects or locations as well as individuals. Improper storage and handling of food products may result in sickness or even death of people who eat such food. The fact that improper handling or storage has occurred is often difficult or impossible to determine. If a shopper places a package of meat on a shelf in another area of a store, a store employee may merely return that package to the meat case without knowing how long the meat has gone without refrigeration. Another shopper could easily purchase that meat package, never knowing that it had been left without refrigeration for a potentially long, and unhealthy, period of time.

In another example, individuals having early stages of dementia may forget to take, or believe that have already taken, medications. It can therefore be difficult to ensure that medication or drugs are administered properly without continuous supervision.

It would be desirable to have a system to manage and monitor the status of conditions or events of objects and individuals, as well as their environment, and to utilize the information collected to perform warning or remedial functions, or alert a responsible party in order to reduce problems that could otherwise become severe if not for an intervention.

### SUMMARY

It is therefore an object of the disclosure to provide a system and method for monitoring and detecting the status or change of a condition, or the occurrence of an event, applicable to an individual, object or a location. The information collected that relates to the status or change of the condition is used to provide an appropriate response or remedy to problems or situations that may be detected.

### BRIEF DESCRIPTION OF THE DRAWING

The above-mentioned and other advantages of the disclosure, and the manner of obtaining them, will become more apparent and the disclosure itself will be better understood by reference to the following description of the embodiments of the disclosure taken in conjunction with the accompanying drawing, wherein:

FIG. 1 is a diagrammatic view of one embodiment of a condition monitoring system in accordance with the disclosure.

FIG. 2 is a perspective view of a garment having a wetness sensor in accordance with one embodiment of the disclosure.

FIG. 3 is an exploded perspective view of the garment depicted in FIG. 2.

FIG. 4 is a perspective diagrammatic view of a practical application of one embodiment of the disclosure.

FIG. 5 is a perspective view of a sensor in accordance with one embodiment of the disclosure.

FIG. 6 is a top plan view of a mattress in accordance with one embodiment of the disclosure.

FIG. 7 is a diagrammatic view illustrating signal flow for a condition monitoring and management system in accordance with one embodiment of the disclosure.

FIG. 8 is a diagrammatic view illustrating signal flow for the condition monitoring system shown in FIG. 7, applied to multiple locations.

FIG. 9 is a perspective view of one application in accordance with an embodiment of the disclosure.

FIG. 10 is a diagrammatic view of a condition monitoring and management system in accordance with one embodiment of the disclosure.

FIG. 11 is a plan view of an individual wearing sensors in accordance with an embodiment of the disclosure.

FIG. 12 is a diagrammatic view illustrating multiple features and capabilities of the disclosure.

FIG. 13 is an exploded diagrammatic view of another embodiment of the disclosure related to monitoring of packaged food items.

FIG. 14 is a diagrammatic view of another embodiment of the disclosure related to monitoring of medications.

FIG. 15 is a diagrammatic view of another embodiment of the disclosure related to monitoring of different types of products.

Corresponding reference characters indicate corresponding parts throughout the various figures of the drawing.

### DESCRIPTION OF THE EMBODIMENTS

The embodiments of the disclosure described below are not intended to be exhaustive or to limit the disclosure to the precise forms disclosed in the following detailed description. Rather, the embodiments are chosen and described so that others skilled in the art may appreciate and understand the principles and practices of the disclosure.

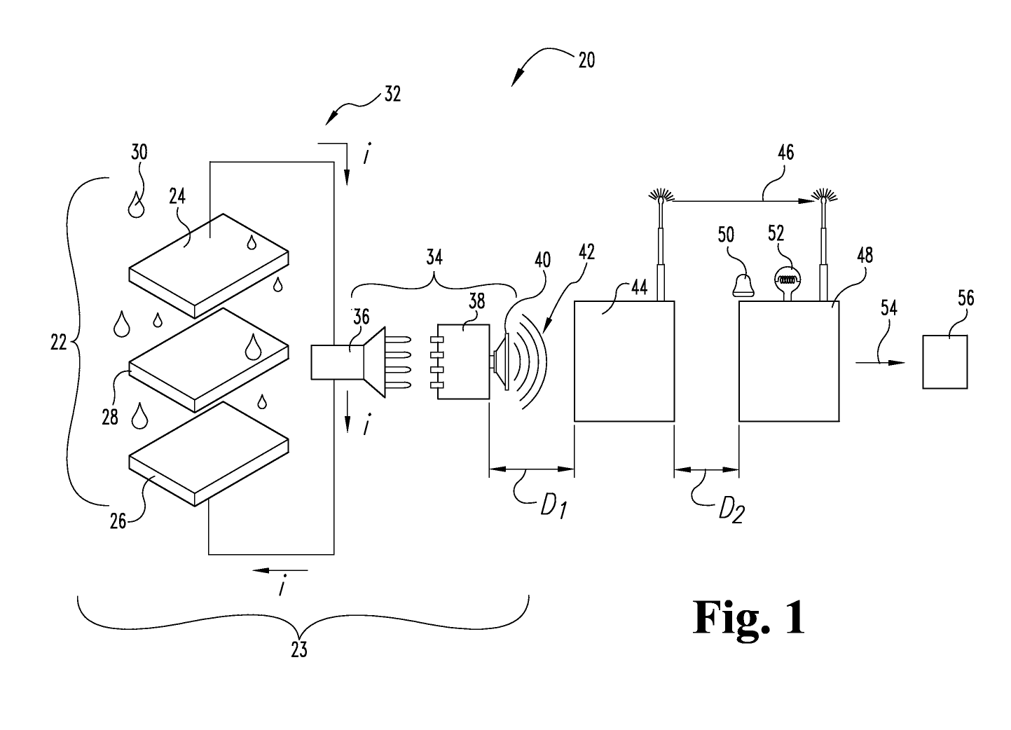

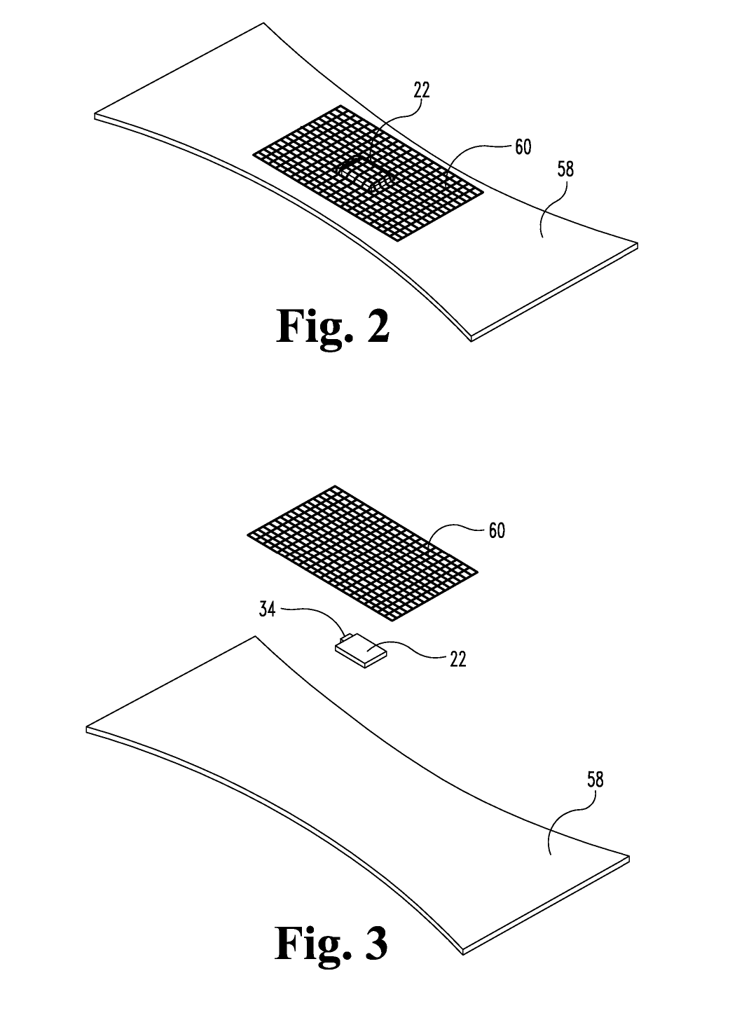

Referring now to FIG. 1, there is shown one embodiment of a system 20 of the disclosure where system 20 is used for detecting and signaling that a person has become incontinent. System 20 illustratively is shown to include a wet cell battery 22, which further includes, in the example of FIG. 1, an anode 24, a cathode 26 and an absorbent material, such as membrane 28, disposed therebetween. In one application, battery 22 may be incorporated into a garment, such as a diaper, for example, as shown in FIGS. 2 and 3, and as described in more detail below. Membrane 28 is preferably impregnated with a salt, such as NaCl as one example. In operation, when battery 22 becomes wet with urine, the salt in membrane 28 disassociates into positive and negative ions, allowing electrons to travel from the cathode back to the anode, thereby creating a current flow. In this way battery 22 acts as a wetness or incontinence detector. Wet cell batteries are well-known in the art and their operation need not be described in further detail herein. Technology is also available to manufacture paper batteries, as well as paper antennas, with conductive ink, thereby further simplifying the manufacture of the components of system 20.

In the illustrated embodiment of FIG. 1, anode 24 and cathode 26 may be made from thin foil of suitable dimension, and membrane 28 may be made from cotton cloth, cellulose fibers, non-woven polyethylene or polypropylene, or some other porous, conductive or non-conductive membrane. Anode 24 and cathode 26 may also be made from aluminum, steel, copper, composites of these metal, or other suitable materials.

In the illustrated embodiment of FIG. 1, membrane 28 may be impregnated with potassium chloride and sodium chloride in trace amounts, and the assembly of battery 22 may be accomplished through a laminated assembly process.

As shown in FIG. 1, current flow 32 (identified by arrow i) powers annunciation device 34 that is made up of a base or first member 36 through which the current passes, and a second or attachment member 38 that incorporates a speaker 40 which produces an acoustic signal schematically illustrated by sound rings 42. In the embodiment of FIG. 1, device 34 is illustratively made in a combination of hand and automatic assembly and made available, for example, by SMT Sales, Inc., 319 E. 11^{th} Street, Elmira Heights, N.Y. 14903. Device 34 may, for example, include a semiconductor timer, such as that identified by the designation LM555 (available from National Semiconductor), which can be used to measure the degree of wetness based on the timer output frequency.

While device 34 is shown in the embodiment in FIG. 1 as producing acoustic signal 42, it would be readily recognized by one of ordinary skill in the art that current flow 32 generated by battery 22 could be used to power a wide variety of other signal producing devices, including but not limited to, radio frequency (rf) transmitters, light bulbs, light emitting diodes (LEDs), infrared signal transmitters, and electromagnetic (e.g., piezoelectric) devices. If device 34 is configured to produce an acoustic signal, for example, an acoustic converter 44 is preferably positioned a distance D₁ from device 34. Distance D₁ will be chosen based on the volume of the acoustic signal produced by device 34. In the illustrated embodiment of FIG. 1, converter 44 is made in a combination of hand and automatic assembly and made available, for example, by SMT Sales, Inc., 319 E. 11^{th} Street, Elmira Heights, N.Y. 14903. In one application, for example, converter 44 may be mounted to the bed of the patient wearing battery 22 and device 34. The combination of battery 22 and device 34 are referred to herein as sensor 23. Sensor 23 may be manufactured as part of a diaper and made disposable, e.g., with a paper battery and paper antenna, or it may be implemented in a reusable smart card that is inserted into a slot formed into the diaper during manufacture. The smart card could also store identification or condition monitoring information for use at a later time.

In the example of FIG. 1, converter 44 receives acoustic signal 42, amplifies it and converts it to a radio (e.g., rf) signal 46 that is transmitted to transceiver 48. The distance between converter 44 and transceiver 48 is shown in FIG. 1 as D₂. Clearly, D₂ can be much greater than D₁, as D₁ is limited by the signal volume or loudness of speaker 40 of device 34. In the illustrated embodiment of FIG. 1, transceiver 48 is made in a combination of hand and automatic assembly and made available, for example, by SMT Sales, Inc., 319 E. 11^{th} Street, Elmira Heights, N.Y. 14903. It should also be appreciated that system 20 may be designed and constructed to eliminate device 34, such that detection of wetness by battery 22 directly causes converter 44 to transmit a signal to transceiver 48. The nature of the types of devices used in system 20, as well as the types of signals produced by those devices, may be chosen in accordance with the environment in which such devices are used or located. For example, if rf energy signals are deemed to be problematic in a hospital environment, audio, light-producing, or infrared devices may be required or desirable. It is also understood that the various devices and components of system 20 may be hard-wired to each other if desired or required under particular conditions.

In one application of the disclosure, transceiver 48 may be located outside the room of a patient and mounted to a wall, for example. Transceiver 48 may be configured with one or more signal-producing devices, such as audible signal device 50 and/or light 52. Transceiver 48 may also relay a signal 54 to a base station 56. In one embodiment, base station 56 is located at a health care facility nurse's station, but it could be located central to a particular facility, or at some other facility any distance away. Base station 56 may be configured to receive signals 54 from multiple transceivers, collectively designated as 48, that are located within different patient rooms in the same facility, or from different facilities entirely.

In another embodiment, transceiver 48 or base station 56 may be represented as a bracelet-mounted, necklace-mounted, belt-mounted, or wall-mounted device, any of which may incorporate a light bulb, buzzer, or radio transmitter or transceiver, for example, to provide an immediate alert signal to someone in the vicinity or remote from the patient or location of the alert event. Transceiver 48 or base 56 may also contain electronic or computer memory storage for storing signals and data for later review, evaluation, or storage.

Turning now to FIGS. 2 and 3, battery 22 can be installed in a garment 58, such as a diaper, absorbent pad, sleeping garment, bed pad, wound dressing or bandage. Mesh 60 is preferably made from a material that will spread or wick urine or some other body fluid to battery 22, thereby activating it. That is, until membrane 28 becomes wet, battery 22 does not generate a current. Many suitable materials for mesh 60 are known in the art, such as, but not limited to, polyester and natural fibrous materials. In the illustrated embodiment of FIGS. 2 and 3, garment 58 is made of multiple layers of nonwoven, spunbond polyethylene and polypropylene, laminated to multiple layers of absorbent cellulose material. Battery 22 is inserted within the mesh layers in a combination of hand and automatic assembly and made available, for example, by SMT Sales, Inc., 319 E. 11^{th} Street, Elmira Heights, N.Y. 14903. Battery 22 may be also activated by other means such that an embedded battery may be provided as convenient and available power for one or more sensors, for example, or to operate a transceiver or other alert device.

Of course, conditions other than wetness may also be monitored. A variety of testing apparatus or components may also be incorporated within sensor 23. For example, the specific gravity of the urine may be measured to determine if a patient is dehydrated. Other measurements, such as urine pH, muscle contraction, and the amount of urine expelled (by measuring change in weight of diaper or pad, for example), can be used to determine other health or body conditions. Other tests or measurement, including the use of other types of sensors, would be readily apparent to one skilled in the art, including but not limited to, the identity of the individuals who checked on and administered care to the patient, time conditions such as when diaper wetness occurred and when such conditions were treated, as well as the type of product that was applied to the patient, e.g., size and style of diaper or pad.

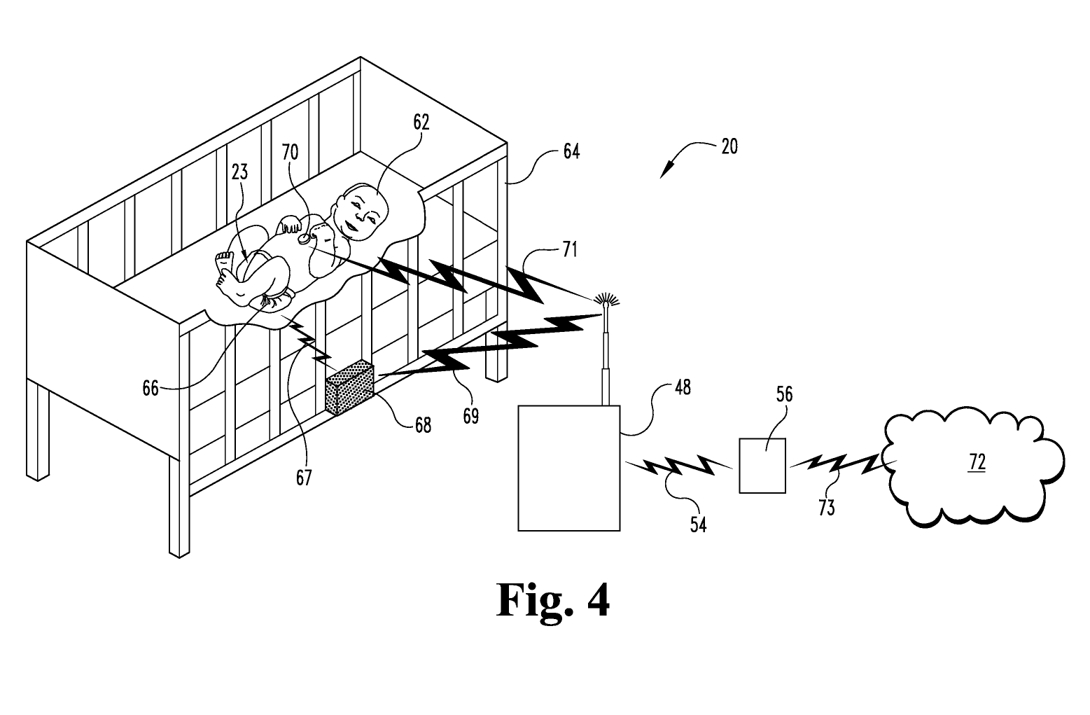

With reference to FIG. 4, particular benefits of system 20 are shown. Infant 62 in crib 64 is shown wearing a garment 66 having sensor 23, as described above. Although FIG. 4 shows an infant, system 20 is equally applicable to adults as well, with a bed or chair, for example, being substituted for crib 64. When infant 62 (or adult, as the case may be) urinates, battery 22 in sensor 23 generates a current, which in turn produces a signal 67, e.g., acoustic or otherwise. Detector 68 (which corresponds in function to converter 44 in FIG. 1) illustratively converts signal 67 received from sensor 23 to a radio frequency signal 69, amplifies it, and transmits it to transceiver 48. In turn, transceiver 48 relays a signal 54 to base 56. In the embodiment illustrated in FIG. 4, base 56 may be a central station in a day care facility, for example. Base 56 may receive multiple signals 54 from multiple transceivers 48 that are located in different rooms of the facility, for example. An operator positioned at base 56 may dispatch a caregiver to perform some service, such as changing the diaper of infant 62, when an appropriate signal 54 is received.

Other conditions of infant or patient 62, or of the environment surrounding infant or patient 62, can also be monitored, including but not limited to, blood pressure, respiration rate, body and room temperature, humidity, and lighting status, as described in more detail below. As one example, a sensor 70 may monitor heartbeat. Sensor 70 may also be made available, for example, by SMT Sales, Inc., 319 E. 11^{th} Street, Elmira Heights, N.Y. 14903. Sensor 70 may be configured to send a signal 71 to transceiver 48 when an infant's heartbeat stops or becomes irregular. Transceiver 48 thereafter transmits a signal 54 to base 56. Advantageously, system 20 can be linked to a communications network, for example the internet, as shown by reference numeral 72. In that way, information received by base 56 can be uploaded to the internet, as illustrated by signal 73 in FIG. 4. This process may be accomplished by means such as a computer or wireless device that may be incorporated in base 56. If infant 62 is being watched at a day-care facility, the parents of infant 62 can log on to a specific web site to check whether the diapers of infant 62 are timely being changed, or if the physical condition of infant 62 is otherwise normal. The parents could also check other vital signs that may be monitored, such as respiration, heart rate and body temperature. Transceiver 48 may also be used to detect, transmit or record sounds, voices, or conversations. These capabilities are similarly advantageous for private residences, nursing homes and other facilities. Significantly, the disclosure provides a powerful tool for family members or others to determine the current state of health (e.g., fever, dehydration) as well as to ensure that their loved ones (or monitored patients) are receiving proper care.

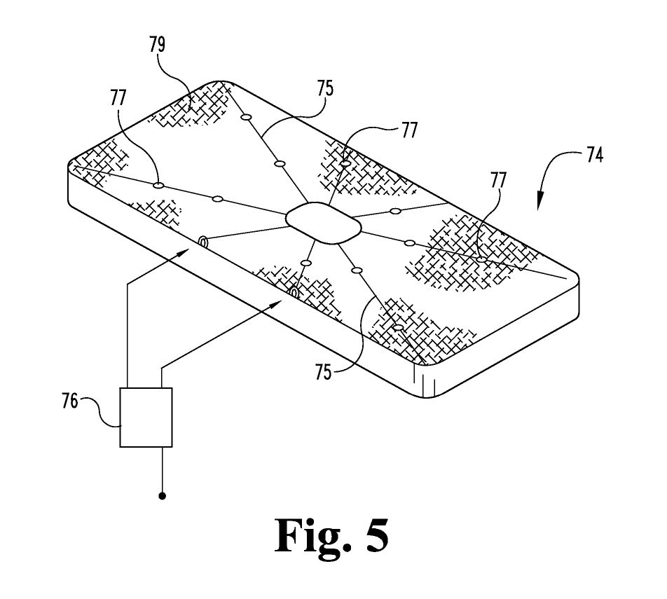

Turning to FIG. 5, a mattress 74 may be configured such that it produces a signal in response to a multiplicity of conditions, including, as non-limiting examples, the presence of blood from a wound, wetness due to incontinence, heart rate, respiration rate, body temperature, or lack of movement. In the illustrated embodiment of FIG. 5, mattress 74 is a typical bed mattress that has microfilament conductive elements 75, such as for example, wires or conductive threads, interspersed throughout the surface of the mattress in a variety of patterns and in physical contact with multiple, dispersed sensors, e.g., microsensors, 77. FIG. 5 shows a cotton textile overlay 79, such as a typical fitted bed sheet, that has microfilament elements 75 and sensors 77 sewn or screen printed onto textile sheet 79. Each microfilament element 75 uses the same principal condition detection method described with respect to FIG. 1. Signals indicative of the condition detected by the sensors 77 are conducted via microfilament elements 75 to connectors 81 that are connected to transmitter 76 in either a detachable or permanently attached manner. Transmitter 76 may then in turn transmit a signal indicative of the conditions detected by sensors 77 to a monitoring location or facility. Sensors, such as sensors 77 may be located on a variety of products or items, such as, for example, clothing, bandages, and diapers, and connected to radios or transceivers, such as transceivers 48, by conductive threads, for example, that can illustratively be woven or threaded into the relevant products. Such a product could also be a pad, e.g., made of soft, non-allergenic non-woven material having a pressure sensitive adhesive backing, that could incorporate a sensor and transceiver, connected by conductive thread, that could be placed wherever a particular condition was desired to be monitored or measured.

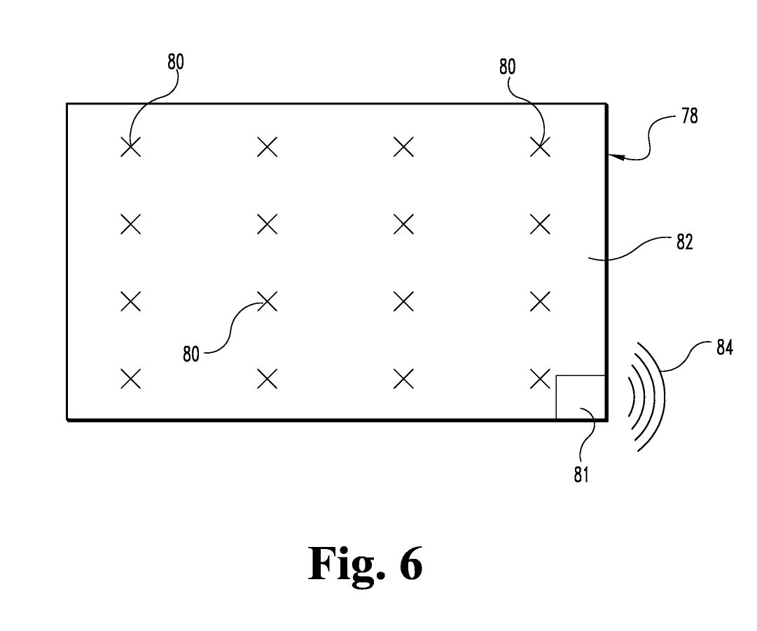

In the illustrated embodiment of FIG. 5, transmitter 76 may also provide power to sensors 77 in mattress 74, or sensors 77 in mattress 74 may be “passive.” FIG. 6 presents another example of a mattress 78 which includes multiple transducers (i.e., sensors) 80 disposed within a “smart pad” 82 placed on top of mattress 78. Transducers 80 could be configured, for example, to detect movement, or lack thereof, in a bed. Further, transducers 80 may be configured to detect where specifically on the bed a patient is located or whether the patient is no longer in the bed. Transducers 80 may further be configured to generate a signal that is applied to annunciator or transmitter 81 which in one example produces acoustic signal 84 to alert a caregiver that a particular condition has been detected. Transducers 80 may comprise a variety of different types of transducers for monitoring and detecting a variety of conditions. Annunciator or transmitter 81 may therefore be configured to receive signals from different types of transducers, and may be capable of determining to which condition a particular signal relates. In this way, annunciator or transmitter 81 may generate different types of signals, e.g., light, bell, horn, or electronic message, depending upon the seriousness of the condition that is being monitored. For example, diaper wetness may cause annunciator 81 to initially turn on a light, while a sudden drop in heart rate or respiration may indicate a critically serious heath problem, such that annunciator 81 sounds a loud horn or buzzer, or sends an electronic message, created via associated computer software, for example. Annunciator 81 may also produce and appropriate signal or message if a patient who has experienced diaper wetness is not attended to within a reasonable period of time following the light or other lower-level alert signal being activated. In this way, system 20 discriminates between signals based on their initial seriousness as well as any escalating seriousness that may result from lack of response given to earlier alert signals.

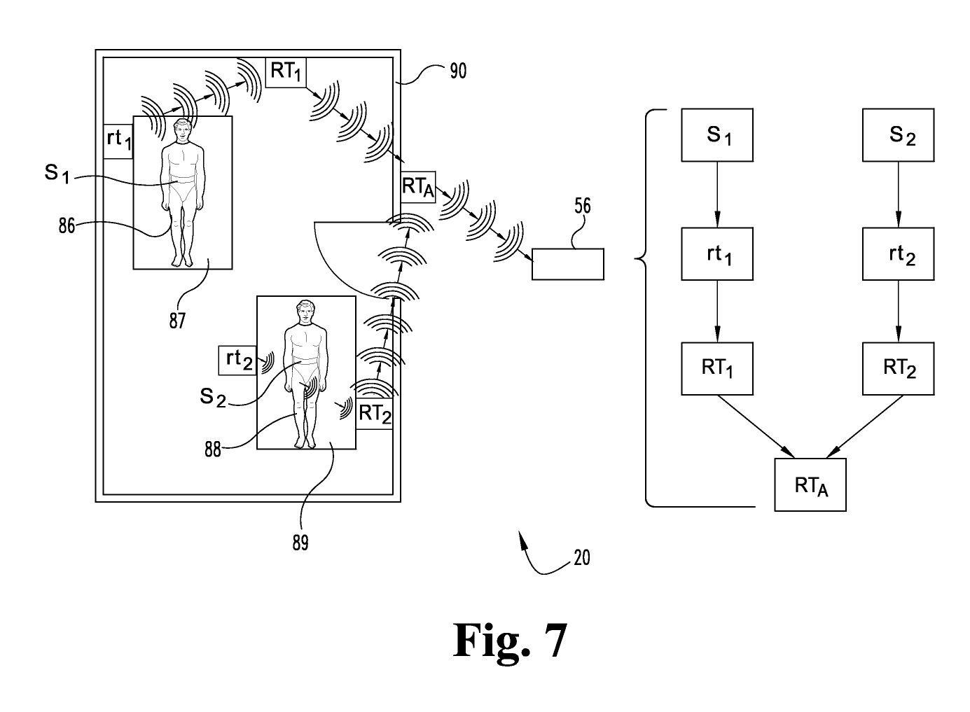

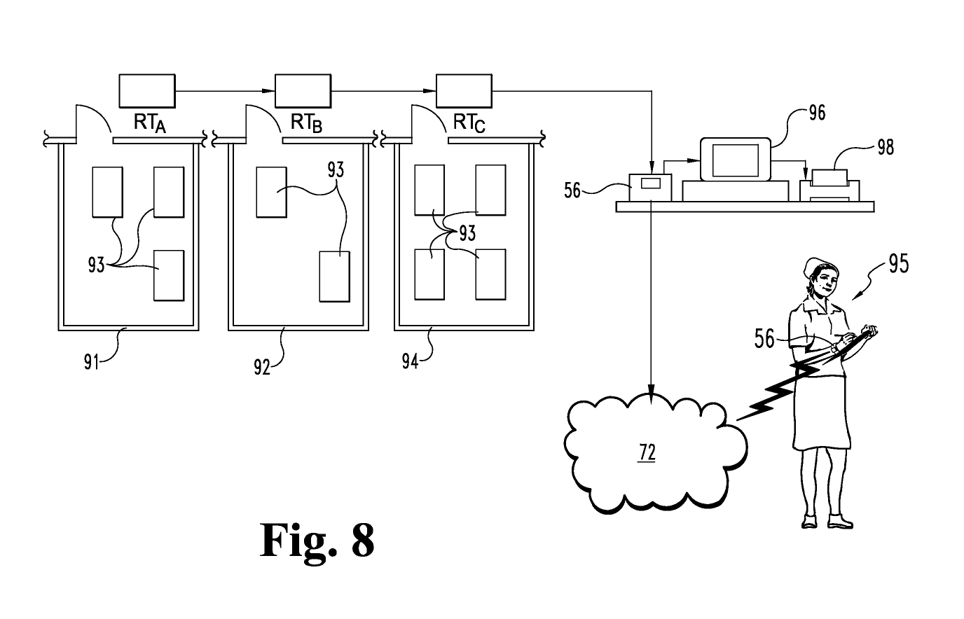

FIGS. 7 and 8 illustrate some of the capabilities of system 20 in accordance with an embodiment of the disclosure. As shown, a patient 86 in bed 87 of room 90 is wearing a garment with sensor S₁ (such as sensor 23 as shown in FIG. 1). Upon occurrence of a condition (e.g., incontinence), sensor S₁ provides a signal to rt₁ (such as converter 44 as shown in FIG. 1). In turn, rt₁ provides a signal to RT₁ (which corresponds to transceiver 48 as shown in FIG. 1). Patient 88 and bed 89 are also located in room 90 and are similarly configured with sensor S₂, converter rt₂ and transceiver RT₂. An intermediate transceiver RT_{A} can be positioned outside room 90 as shown. RT_{A} can provide multiple functions, including producing a signal exterior to room 90 to alert an attendant or other passerby that there is a condition in room 90 that must be checked and attended; and transmitting data to a base station 56. Signal flow for room 90 is represented in a flowchart on the right hand side of FIG. 7. As can be seen, transceiver RT_{A} acts as an information collector or hub, and may discriminate between the signals from RT₁ and RT₂ in order to process the signal indicating the most serious or critical condition vis-à-vis patients 86 and 88.

As shown in FIG. 8, information can be relayed among several rooms 91, 92 and 94, each having one or more beds designated as 93 and configured to provide appropriate condition-identifying signals, to transceivers RT_{A}, RT_{B} and RT_{C}. Information may also be collected from each patient, or for each room, by attendant or caregiver 95 via a wrist or neck-worn base 56 as described in connection with FIG. 1. Transceivers RT_{A}, RT_{B} and RT_{C} (. . . RTₙ) can relay their signals to base station 56 serially (as shown) or directly. By allowing the transceivers to operate as “repeaters,” the transmitting power of each transceiver can be maintained at a low level, thereby requiring less power to operate as well as reducing the chance of signal interference. Any transceiver in the vicinity of the originally transmitting transceiver can then operate in a piggyback or repeater mode, relaying a signal to another transceiver or to base station 56. Base stations 56 may relay the information to internet 72, as shown, via a telephone or cable modem, via USB, infrared or other peripheral connection technology, or via an acceptable wireless protocol, such as the Bluetooth wireless protocol administered by Bluetooth SIG, Inc. Data is also received and stored by computer 96, which in turn is connected to printer 98 that may be used to generate hard copy reports.

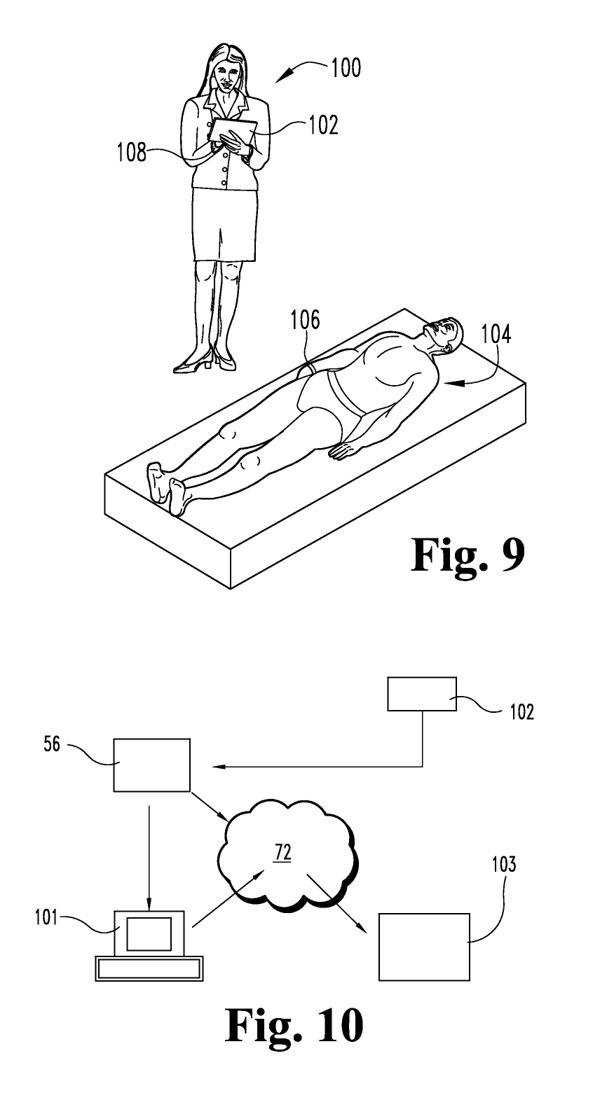

The system of the disclosure can also be used to help, for example, a personal caregiver, physician, pharmacist, or nurse administer aid to a patient. With reference to FIG. 9, an illustrative example shows a patient 104 being treated by a nurse 100. Nurse 100 is equipped with a personal digital assistant (“PDA”) 102. One type of PDA is sold under the Palm brand. Other suitable PDA-type devices are mobile phones, cellular phones and pagers. PDA 102 is configured with a recognition system that confirms nurse 100 is treating the correct patient. One such recognition system may include a fingerprint recognition pad, a heartbeat identification receiver/scanner, or some other device that can accurately verify the identify of a patient. Patient 104 may also be configured with a bracelet 106, or some other type of wearable device, which includes patient data and is capable of transmitting the same to PDA 102. Nurse 100 may also wear a bracelet 108 that includes identification information about nurse 100 that may also be transferred to PDA 102. Information may be transferred or communicated between devices by other means as well, such as by USB ports or connectors, as one example.

Once PDA 102 reads or otherwise obtains information about patient 104, either by means of bracelet 106 or by a recognition system such as those described, PDA 102 may provide instructions for nurse 100 to administer treatment such as medicine to patient 104. PDA 102 may then prompt nurse 100 to confirm that the medicine has been administered, thereby creating a patient record. Such patient records may be utilized, for example, during a medical emergency to determine if a patient has been given or taken the proper medication.

FIG. 10 illustrates how information such as that acquired from nurse 100 can be managed. As shown, patient data and treatment information stored on PDA 102 may be made available in real time on the internet, for example, to family members of the patient, or to the patient's physician or healthcare provider management or medical payor, such as a medical insurance company. As illustratively shown in FIG. 10, information from PDA 102 is transferred to base station 56, such as by a USB connection, or by wireless technology, as two non-limiting examples, which may upload that information to internet 72 directly, or through intermediate means, such as computer 101. The information is then made available to authorized persons, i.e., persons having access rights as deemed necessary in view of patient privacy rights, via internet access device 103, such as a computer, PDA, or cellular telephone, for example, as described above. Base station may also initiate a call to a health care administrator, to emergency medical personnel, or to a patient's family, should the status of a condition warrant it. For example, if an incontinent patient had not be changed for a long period of time, base station 56 could initiate a call to the patient's spouse or other family member informing them, perhaps through a computer-generated message, that their loved one was not receiving proper care.

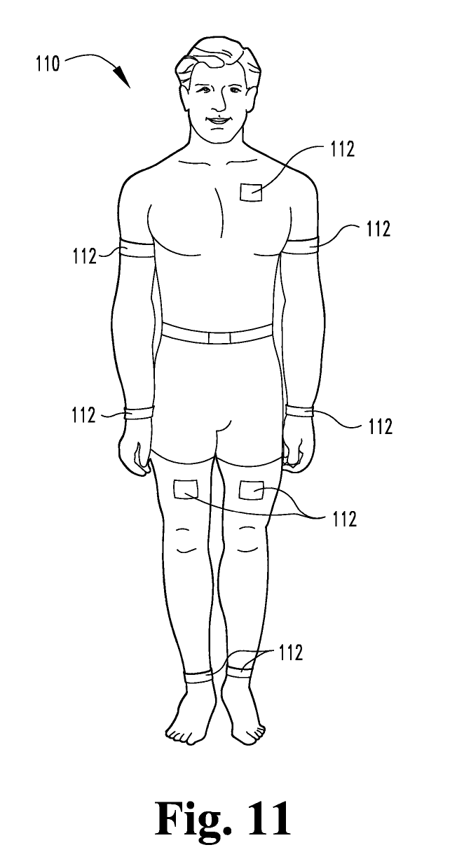

As made clear from FIG. 11, the disclosure is not limited to the monitoring and management of any particular patient condition. As shown, many conditions can be monitored, such as blood pressure, brain activity, blood oxygen saturation, heart rate, respiration rate, incontinence, body temperature, muscle activity, sudden movement or impact (indicating a fall may have occurred), medication history, treatment history, as well as patient location or environmental conditions, such as ambient or room temperature, humidity, carbon monoxide level, to name just a few non-limiting examples. In accordance with one embodiment, a bandage 113 is configured to sense seepage or soak-through via a sensor 112 (which may also incorporate an embedded battery) and provide an alert signal that signifies, for example, either a worsening wound or time for routine changing of the bandage or dressing. Incorporation of GPS technology, for example, into one or more sensors or transceivers can allow the location of a patient or caregiver to be accurately determined in order to ensure that patients have not moved or left a facility unnoticed, and that caregivers are actually where they are supposed to be located at a given time. FIG. 11 shows a representative patient 110 having a number of sensors, designated 112, located proximal to or in contact with his body, including sensor 112 incorporated within bandage 113. Sensors 112 communicate with devices such as converter 44 and transceiver 48 in order to provide the necessary patient condition data which is then processed in a manner that generates appropriate alert signals in an appropriate hierarchical order indicative of the degree of criticality of the status of the condition being monitored. One application could be to use system 20 as a conventional audible baby monitor along with an indicator, such as a light, to indicate some other condition, such as wetness. In this way, a parent or caregiver hearing a baby cry over the monitor would have additional information to determine the reason for crying.

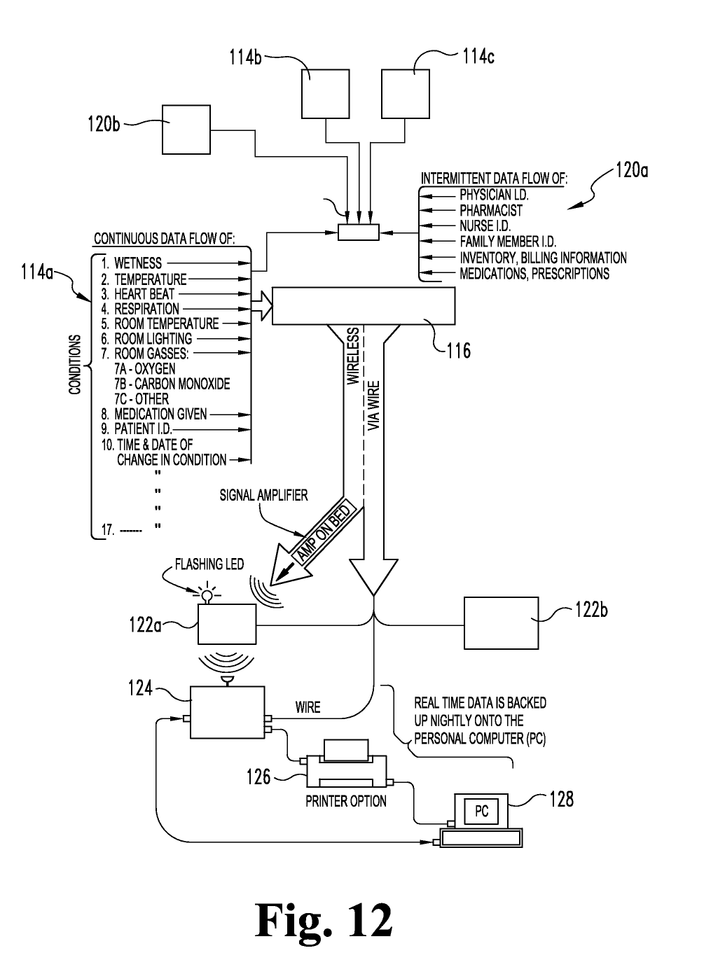

FIG. 12 provides a flowchart that illustrates through one example many of the features of the disclosure and their relation to one another. The figure also illustrates data flow from the point of sensing of a condition to various data output devices. List 114a includes a number of possible conditions that may be monitored or measured by the system of the disclosure. List 114a is not intended to be all inclusive, but only to act as representative examples of monitorable conditions. Typically each condition will be associated with a separate sensor, but some sensors may be sufficiently sophisticated or complex to monitor multiple conditions. Output signals from the sensors associated with list 114a are applied to processor 116, which may include devices similar to converter 44 and transceiver 48, or some other device or circuitry that performs similar functions. Other patients having their own associated lists, such as lists 114b and 114c, for example, may also provide information to processor 116. Verification of patient identity may be done by verifier 118 through fingerprint recognition or some other form of identity recognition, such as retinal scan, DNA identification, or other biometric data, for example. Caregiver or authorized person information, represented by lists 120a and 120b, may also be verified by verifier 118. Proper verification of patient and, in some cases, authorized persons, may be required by verifier 118 before processor 116 accepts information from the sensors associated with lists 114a, 114b, or 114c, or those persons associated with lists 120a or 120b.

In accordance with an aspect of the disclosure, processor 116 identifies and discriminates the items of information that are generated by the various sensors. The signal hierarchy, as described previously, may determine the nature of the alert that is activated or sent to the nurses station, for example, as well as any escalation of alert that may be needed due to a failure to timely respond to a lower level alert. In one example, an electronic message may be created and sent to the appropriate recipient. The hierarchy may also be used to determine who has access to particular information. For example, information concerning room temperature may not be made available to the patient's family, but patient body temperature or heart rate would more likely be made available. Processor 116 also determines the order in which signals should be processed from different patients and/or different rooms or locations. The information hierarchy created by processor 116 controls the operation of alert displays 122a and 122b. The information from processor 116 may be transmitted or otherwise transferred to various devices, such as alert devices 122a and 122b (and possibly many other alert devices as well), by either wired or wireless means. Alert device 122a is shown as also incorporating wireless transmission means, which may be via cellular phone communications, or via the internet, for example, that communicates with receiver 124. Receiver 124 may also receive information signals by hardwire means as well. Receiver 124 is illustratively shown as being connected to a printer 126 and a computer 128, although connection to other devices, by wired or wireless means, is also contemplated.

The examples given have primarily dealt with the monitoring of conditions related to infants, or to patients in health care facilities. Monitoring of individuals for other purposes is also contemplated by the disclosure, such as the location of students within a school, locating a patient (e.g., Alzheimer sufferer) who wanders unnoticed out of a nursing home facility or away from home, aiding in finding abducted children or children who run away from home, or any number of other possible purposes.

Existing technology that can be useful in implementing embodiments of the disclosure is available from Westinghouse Lighting Systems Division under the name Retrolux. This technology incorporates wireless communications technology associated with fluorescent lighting fixtures and bulbs that may be used to provide the necessary communications link for the devices in system 20 described herein. Outdoor alert signs or billboards may also be used in connection with this technology.

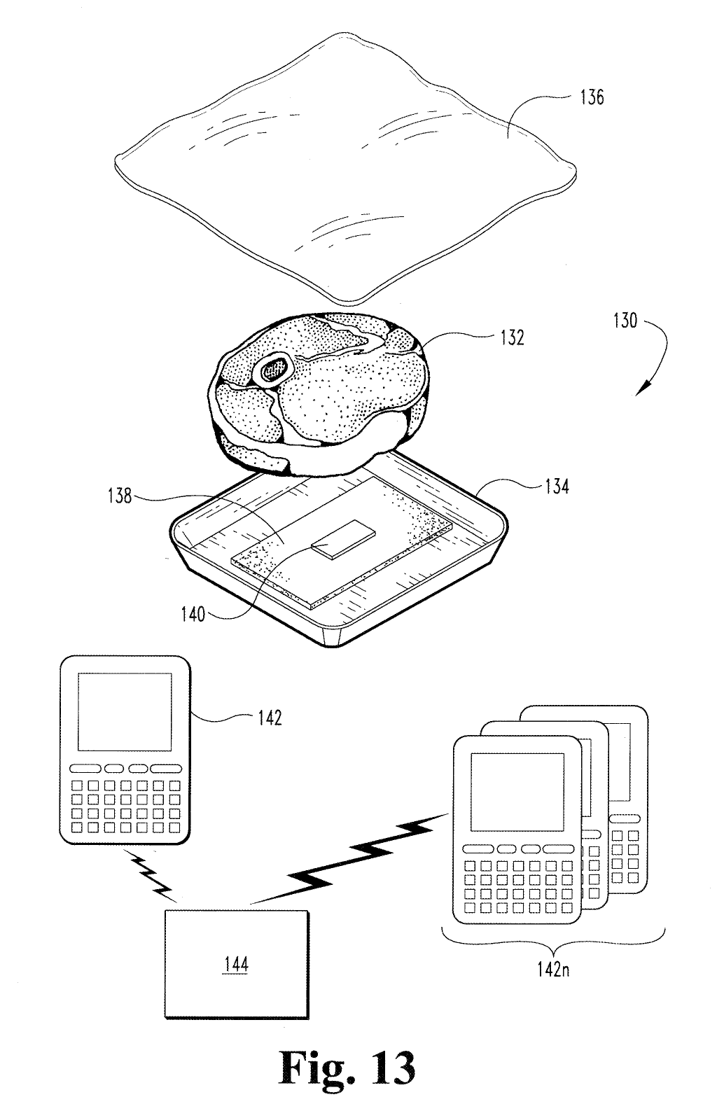

In accordance with another aspect of the disclosure, condition monitoring is not limited to conditions associated with individuals. Conditions of animals or objects may be monitored as well, with physical location and body or health conditions of animals in homes, zoos and in the wild being possible. FIG. 13 illustrates a monitoring system 130 which is used to monitor the condition of an object, for example, the quality of the environment in which meat or other food is packaged. System 130 illustratively includes a selection or cut of meat 132, e.g., steak or roast, conventionally packaged with a foam tray 134 and plastic overwrap 136. Pad 138, which may be used to control moisture within the package, is disposed between meat 132 and tray 134. A sensor 140 is placed within the package and preferably in contact with meat 132. Sensor 140 may also be incorporated within pad 138 for manufacturing purposes. Sensor 140 may be configured to monitor or measure one or more characteristics, such as, for example, current temperature of meat 132, maximum temperature and time to which meat 132 has been subjected, moisture content, bacterial count, or package expiration date as compared to the current date. Other characteristics may also be monitored as desired.

Information from sensor 140 may be collected via known, conventional means, such as by rf (radio frequency) tagging technology, visual inspection (e.g., sensor 140 may be visible through a transparent area of tray 134) that indicates by color change or other indicia that a particular condition exists or has occurred, or other means that cause sensor 140 and any associated circuitry, such as an embedded battery for power, to transmit or otherwise transfer information to a collection device. Such a collection device may also operate as a transceiver and might take the form of a PDA, or a wrist-worn receiver, for example. In FIG. 13, collection device or transceiver is shown as PDA 142 incorporating wireless communication technology. Information collected by PDA 142 in connection with a particular event may be transmitted to a base station 144 directly (or through one or more “relay” or “repeater” transceivers), which may also collect information from a number of other devices, illustratively shown as PDAs 142n. PDA 142 and/or base station 144, in accordance with an aspect of the disclosure, processes the collected information and creates an information hierarchy that is used to generate alert signals that are applied to various alert systems and to various recipients. For example, an indication that a loaf of bread is hard or stale might generate a message to the department manager that stock should be replaced when convenient, as well as a message to the bread supplier to ensure that proper deliveries are being made. An indication that high bacteria levels was found in a package of meat could generate an alarm that requires immediate action to remove that package before it is inadvertently purchased by a customer who might later become ill. In accordance with an aspect of the disclosure, different recipients can receive different alerts or different information based on the same condition or event.

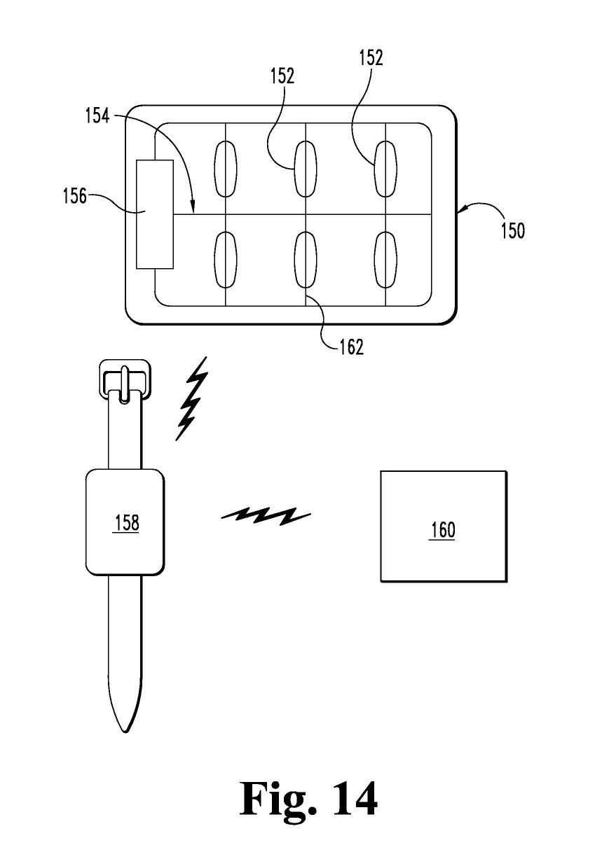

In accordance with another embodiment of the disclosure, FIG. 14 illustrates a medication package 150 illustratively in the form of a blister pack having pill blisters 152 within each of which is placed a pill or capsule, for example. Package 150 also includes an electrical connection pattern 154, comprising an electrical circuit having particular, known electrical characteristics (e.g., resistance), which incorporates circuit elements 162, e.g., wire or conductive thread, that traverse each pill blister 152. Electrical connection pattern 154 may be placed on the surface of blister pack 152, or it may be placed between layers of foil, for example. Electronic circuitry 156 is connected to electrical connection pattern 154 and monitors or measures the electrical characteristics of connection pattern 154. Circuitry 156 also illustratively incorporates the components necessary to perform the function of transmitting information to transceiver 158, shown illustratively in FIG. 14 as a wrist-worn device. Transceiver 158 in turn transmits the received information to base station 160, either directly or through one or more relay transceivers as described above. Base station 160 may monitor a variety of conditions from large numbers of locations via thousands of transceivers at any given time.

In operation, as an illustrative example, each circuit element 162 of connector pattern 154 that traverses or passes over a pill blister 152 exhibits a particular electrical characteristic, e.g., resistance, inductance, or capacitance. When a pill or capsule is removed from package 150 by bursting its corresponding pill blister 152, the associated circuit element 162 is broken, thereby changing its particular electrical characteristic. Circuitry 156 measures or senses this change, which may be characterized as an event, the information of which is transmitted to, or received by, transceiver 158 from which it is sent to base station 160 for analysis. In one embodiment, each circuit element 162 contributes 5000 ohms of circuit resistance. In a package having ten pills, the total measured resistance will be of the order of 50 k ohms. If the measured resistance is only 45 k ohms, it can be concluded that one conductor path has been broken, such that one pill has been removed from the blister pack and nine pills remain. The actual circuit resistance measurement (which may be manifested in a change in signal frequency or other characteristic, for example) can be done via the use of an industry-standard timer circuit, such as an LM555 semiconductor chip, in a manner that is known to those skilled in the art.

Using this pill-monitoring arrangement in conjunction with techniques previously described, it is possible to monitor patient adherence to prescribed dosing schedules. Dosing schedules may be programmed into local or base devices, e.g., transceiver 158 or base station 160. If a patient fails to take medication at the proper time, or overtakes the medication, an alert signal will be generated. The alert may be sent, for example, to the patient as a reminder if a medication dose is missed, to a caregiver if the patient is unable to properly administer their own medication, e.g., Alzheimer patients, or to an emergency response facility in the case of a medication overdose. Multiple reminders, with particular individuals, e.g., caregivers or emergency response personnel, being added to subsequent reminders, can therefore act as a means to escalate a situation if it is not resolved in a timely fashion. It is obvious that the apparatus and methods described may be employed in critical as well as non-critical applications. In one embodiment, all medications taken by a single patient or individual can be monitored to determine if there is a risk of occurrence of any drug, medication, or food interaction, regardless of the number of doctors from which a patient may receive medication, or when it is time to refill a prescription, for example.

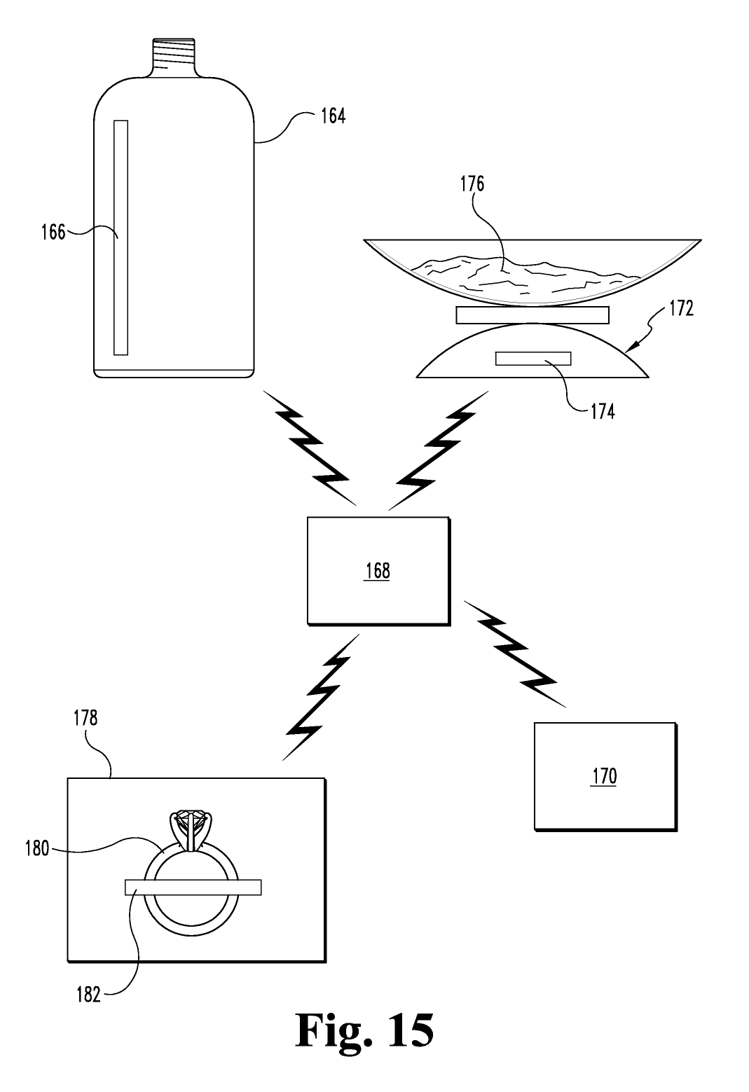

As can be seen in FIG. 15, the previously described pill dosing monitor may also be adapted for use with vitamins or other forms of medications (either prescription or over-the-counter), such as liquid medication 164 via sensor 166 which communicates its information to transceiver 168 and, in turn, to base station 170. Containers such as bottles and tubes may have sensors that determine content volume dispensed when a bottle is tipped or a tube is squeezed. Through the use of other types of sensors, other conditions can also be monitored, such as, for example, expiration dates or whether perishable food products have been properly stored or refrigerated. Also as shown in FIG. 15, a scale 172, incorporating a sensor 174, can be used to ensure proper portion or size control of a food item 176 for dieters or bariatric surgery patients, for example. Sensor 174 is also shown as communicating with transceiver 168. Each of the sensors used for the purposes described, e.g., sensors 166 and 174, also incorporate, or are associated with, technology that transmits, or makes available, the monitored information to one or more transceivers located in the vicinity of a particular sensor. Through the use of GPS technology, for example, the location of the medication package can be monitored to determine if it remains with the patient or is lost, misplaced, or stolen. Conditions and locations of other types of products, such as syringes, blood glucose or cholesterol test strips, or insulin dosage, for example, can also be monitored and information communicated to a particular location for analysis or response. In all monitoring situation previously described, information and data can be either locally or centrally stored for later analysis and reporting.

Monitoring techniques such as those described above can also be used in a number of other situations, including, for example, management of product inventory (e.g., removal and replacement of items) at the warehouse or retail level, e.g., for an entire pharmacy or store, or for theft control. For example, a monitoring system may be able to determine that certain medications or drugs had been removed from packages at the warehouse or pharmacy, as well as the identify of individuals who were in the vicinity of such packages at particular times. The sensors and associated circuitry for the various monitoring conditions described can be incorporated in original packaging at the time of product or container manufacture, or they can be retrofitted to existing packaging by distributors, retail merchants, or by individuals. For example, the electrical connector pattern 154 as shown in FIG. 14 may be incorporated in package 150 during manufacture, or it may be added to an existing blister pack by a retailer in the form of an adhesive-backed sheet. Sensors may include, for example, photo cells, proximity detectors, lasers, or motion detectors and can be located on products, as described, on shelves, or in a storage area, for example. Individual transceivers can be made to be programmable and reprogrammable, such that one transceiver may be used with different monitoring systems. The identity of the individual performing the programming, as well as the time and nature of the programming, may be monitored and recorded as well. Such programming may be done locally via particular devices, or remotely via wireless technology, with suitable safeguards (e.g., lights or feedback messages) to ensure that the proper device is being programmed correctly. In one example, a medication package sensor could be programmed by a pharmacist at the time a prescription or medication is dispensed. The status of battery power in portable devices can also be monitored remotely. FIG. 15 illustrates an example in which a package 178 containing an item of jewelry, e.g., ring 180, incorporates a sensor 182 that is in communication with transceiver 168. Sensor 182 may be illustratively configured to cause an alarm to be sounded or an alert message to be sent if ring 180 is moved more than a predetermined distance from transceiver 168.

Other examples of object monitoring will be apparent to one skilled in the art and are intended to be included within the scope of this disclosure.

While preferred embodiments incorporating the principles of the disclosure have been disclosed hereinabove, the disclosure is not only limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

What is claimed is:

1. A system for monitoring and responding to conditions and events comprising:
at least one device associated with an object, said device generating at least one measurement associated with at least one condition of said object; and
at least one communication device coupled to said at least one device for initiating at least one of a plurality of actions, the nature of said at least one action determined by said at least one measurement.

2. The system described in claim 1, wherein said at least one condition comprises an ambient condition.

3. The system described in claim 1, wherein said at least one condition comprises a physical condition.

4. The system described in claim 1, wherein said at least one condition comprises a physical location.

5. The system described in claim 1, wherein said at least one condition comprises a removed quantity or amount.

6. The system described in claim 1, wherein said at least one condition comprises a remaining quantity or amount.

7. The system described in claim 1, wherein said at least one condition comprises the identity of a person.

8. The system described in claim 1, wherein said at least one condition comprises the identification of an object.

9. The system described in claim 1, wherein said at least one condition comprises time.

10. The system described in claim 1, wherein said at least one condition comprises the quantity or amount of a food.

11. The system described in claim 1, wherein said at least one communication device operates via wired technology.

12. The system described in claim 1, wherein said at least one communication device operates via wireless technology.

13. The system described in claim 1, wherein said at least one device is programmable to be associated with said at least one condition.

14. The system described in claim 1, wherein said at least one action comprises evaluating said measurement to determine if said condition is normal or abnormal.

15. The system described in claim 1, wherein said at least one action comprises the administration of a medication.

16. The system described in claim 15, wherein said at least one action further comprises the identification, time, and quantity of said administration of said medication.

17. The system described in claim 15, wherein said at least one action further comprise a determination if said medication was properly administered.

18. The system described in claim 15, wherein said at least one action further comprise a determination of any interaction of said medication with any other medication being administered contemporaneously.

19. A system for monitoring and responding to conditions and events comprising:
at least one device associated with an object, said device generating an information signal associated with at least one event associated with said object, said event having a plurality of characteristics; and
a communication device responsive to said information signal for initiating at least one of a plurality of actions, the nature of said at least one action being determined by at least one of said characteristics of said event.

20. A method for monitoring and responding to conditions and events comprising:
providing at least one device associated with an object;
generating at least one measurement by said device associated with at least one condition of said object;
providing at least one communication device coupled to said at least one device; and
initiating at least one of a plurality of actions, the nature of said at least one action determined by said at least one measurement.
